(19) United States
(12) Patent Application Publication
(10) Pub. No.: US 2016/0025335 A1
(43) Pub. Date: Jan. 28, 2016

(54) A REACTOR FOR PROCESSING FEED MATERIAL

(71) Applicant: ENVIROFUSION LTD, Derby (GB)

(72) Inventor: Anthony Reynolds, Derby (GB)

(21) Appl. No.: 14/774,881

(22) PCT Filed: Mar. 10, 2014
(86) PCT No.: PCT/GB2014/050711

§ 371 Date: Sep. 11, 2015

(30) Foreign Application Priority Data
Mar. 11, 2013 (GB) 1304337.7

(51) Int. Cl. F23G 5/027; F27B 7/14; F27B 7/20; F23G 5/22

(52) U.S. Cl. CPC F23G 5/027; F23G 5/22; F27B 7/14; F27B 7/2016; F27B 2007/025

(57) ABSTRACT

The disclosure relates to a reactor for processing feed material, comprising: a de-gasifier zone configured to operate at a de-gasifier temperature and receive the feed material in order to remove components from the feed material that take a gas or vapour form below the de-gasifier temperature; a pyrothermic zone configured to operate at a pyrothermic temperature and receive the feed material from the de-gasifier zone in order to cause pyrolysis of the feed material to release a gas from the feed material; a molten zone configured to operate at a molten temperature and receive the feed material and released gas from the pyrothermic zone; and a heater configured to heat the molten zone to the molten temperature by burning the released gas received from the pyrothermic zone.

The present invention relates to the field of reactors for processing feed materials.

There are many and various ways of dealing with waste materials, including the production of electrical energy from the waste. Possible methods for dealing with waste include incineration, gasification, pyrolysis, the use of plasma or anaerobic digestion.

Typical difficult wastes to handle include asbestos, medical waste, certain hazardous and toxic wastes, classified nuclear waste, and all household, commercial and industrial wastes. It is desirable to provide an apparatus for disposing of at least some of the above categories of waste at a lower capital or operating cost than existing solutions. It is desirable for the apparatus to be able to dispose of materials without the requirement to sort the materials into different categories of waste prior to disposal.

According to an aspect of the invention there is provided a reactor for processing feed material, comprising:
a de-gasifier zone configured to operate at a de-gasifier temperature and receive the feed material in order to remove components from the feed material that take a gas or vapour form below the de-gasifier temperature;
a pyrothermic zone configured to operate at a pyrothermic temperature and receive the feed material from the de-gasifier zone in order to cause pyrolysis of the feed material to release a gas from the feed material;
a molten zone configured to operate at a molten temperature and receive the feed material and released gas from the pyrothermic zone; and
a heater configured to heat the molten zone to the molten temperature by burning the released gas received from the pyrothermic zone.

The temperature in the molten zone can be elevated beyond the rated heater temperature due to the upstream processing of the feed material in one or more of the pyrothermic zone, de-gasification zone and pre-heat zone. Such an arrangement can reduce the amount required to provide a given operating temperature and so provide for a more efficient reactor.

The heater may be rated to a heater temperature that is less than the molten temperature.

The molten temperature may be greater than the pyrothermic temperature. The pyrothermic temperature may be greater than the de-gasifier temperature.

The de-gasifier zone may be located vertically above the pyrothermic zone. The pyrothermic zone may be located vertically above the molten zone. The feed material may be configured to move between the various zones under the action of gravity.

The pre-heat zone may be configured to operate at a pre-heat temperature. The pre-heat zone may be configured to pre-heat the feed material before providing the feed material to the de-gassifier zone.

The pre-heat zone may be located vertically above the de-gasifier zone.

The de-gasifier temperature may be greater than the pre-heat temperature.

The reactor may further comprise a hot air supply configured to heat the de-gasifier zone and/or the pre-heat zone.

The hot air supply may be provided by, or heated by, exhaust gasses from the reactor.

The pre-heat temperature may be between 300° C. and 400° C. The de-gasification temperature may be between 350° C. and 500° C. The pyrothermic temperature may be between 1100° C. and 1350° C. The molten temperature may be between 1400° C. and 2000° C. The heater temperature may be between 1100° C. and 1400° C.

The heater may be a burner. The heater may be configured to burn fuel received from an external fuel source.

The heater may be configured to heat the pyrothermic zone to the pyrothermic temperature.

The molten zone may be configured to provide a molten filter when in use.

The reactor may further comprise a chamber having a toroidal portion and/or a cylindrical portion. The de-gasifier zone and/or pyrothermic zone may be located in the toroidal portion. The molten zone may be provided in the cylindrical portion.

The heater may be located in the central cavity of the toroidal portion of the chamber. The heater may be configured to apply heat to the molten zone in the cylindrical portion of the chamber.

A wall that defines the chamber may be rotatable relative to another wall that defines the chamber in order to stir feed material within the chamber.

The toroidal portion of the chamber may comprise an air duct configured to distribute air from an air intake to a plurality of positions around the toroidal portion of the chamber.

The air duct may extend around a circumference of the chamber. The air duct may comprise a plurality of apertures between a plenum within the air duct and the chamber. The size of the plurality of apertures may increase as a function of distance along the air duct from the air intake. A cross-sectional area of the plenum of the air duct may decrease as a function of distance along the air duct from the air intake.

According to an aspect of the invention there is provided a method of processing feed material, comprising:
receiving the feed material in a de-gasifier zone, and operating the de-gasifier zone at a de-gasifier temperature and in order to remove components from the feed material that take a gas or vapour form below the de-gasifier temperature;
receive the feed material in a pyrothermic zone from the de-gasifier zone, and operating the pyrothermic zone at a pyrothermic temperature in order to cause pyrolysis of the feed material to release a gas from the feed material;
receiving the feed material and released gas in a molten zone from the pyrothermic zone, and operating the molten zone at a molten temperature; and
heating the molten zone to the molten temperature by a heater burning the released gas received from the pyrothermic zone.

Embodiments of the present invention will now be described by way of example and with reference to the accompanying drawings in which:

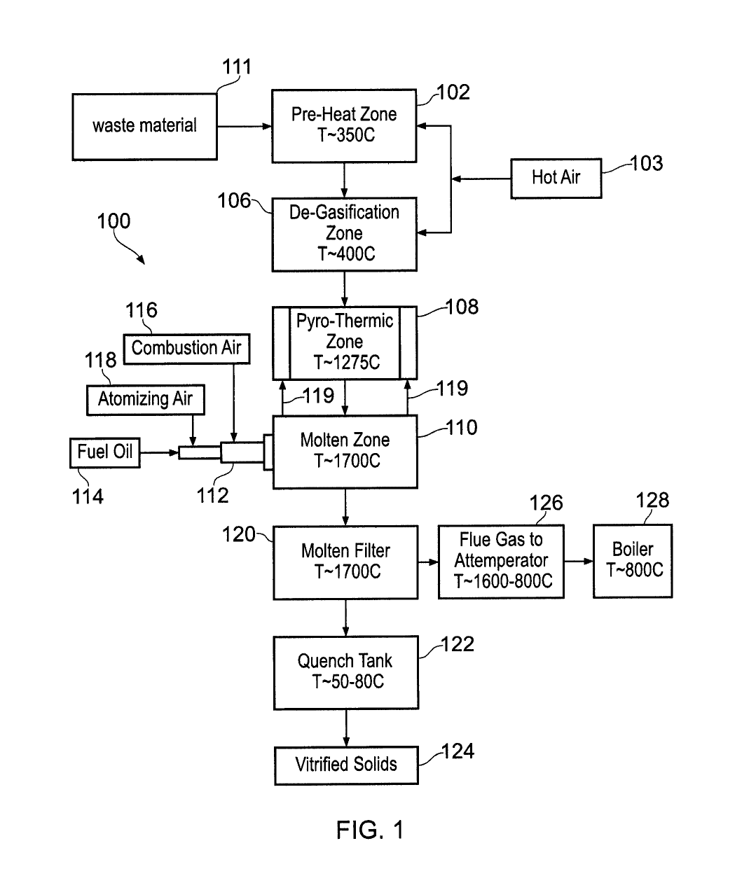

FIG. 1 illustrates a block diagram of a pyrothermic reactor;

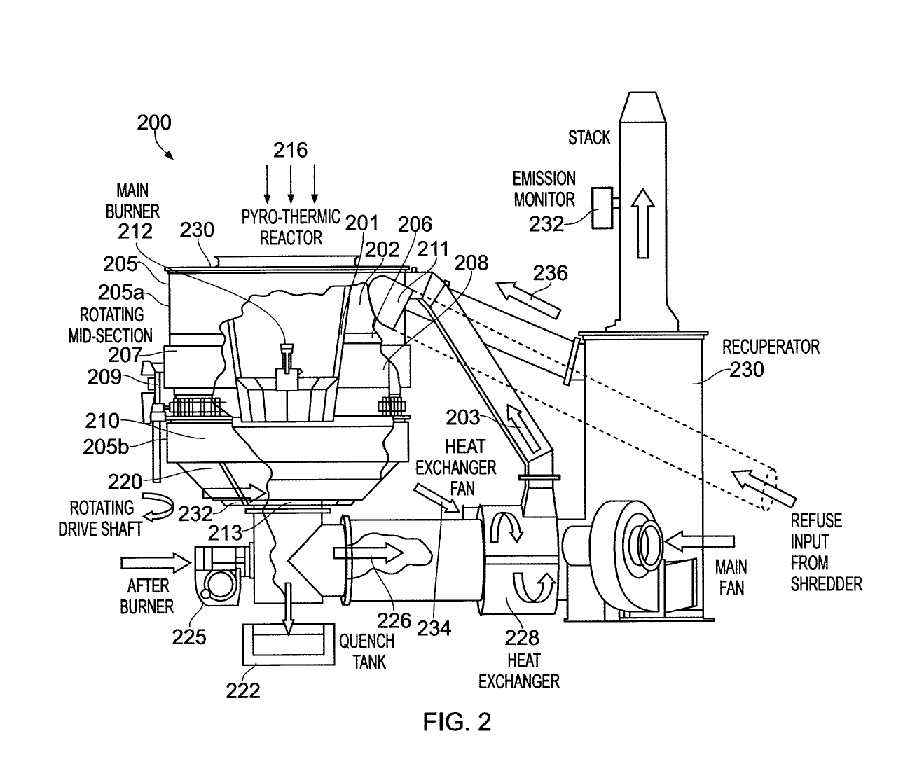

FIG. 2 illustrates a schematic view of a pyrothermic reactor;

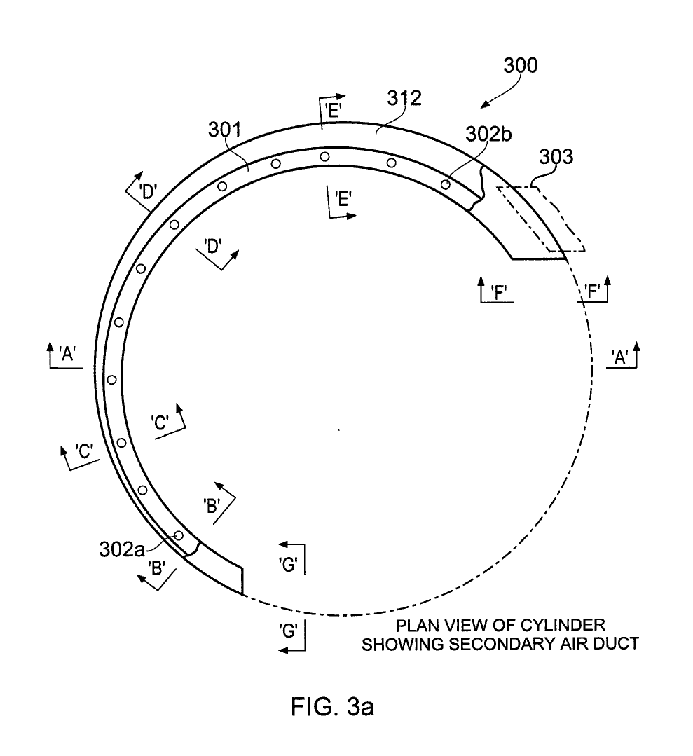

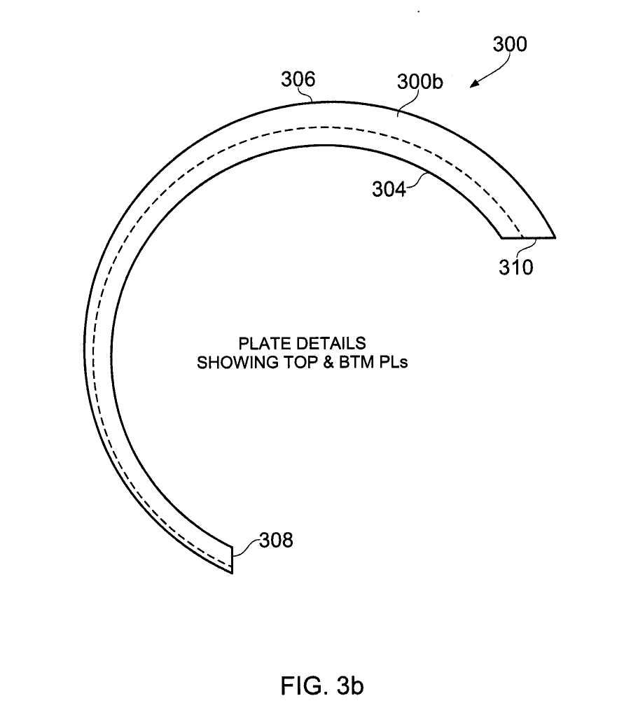

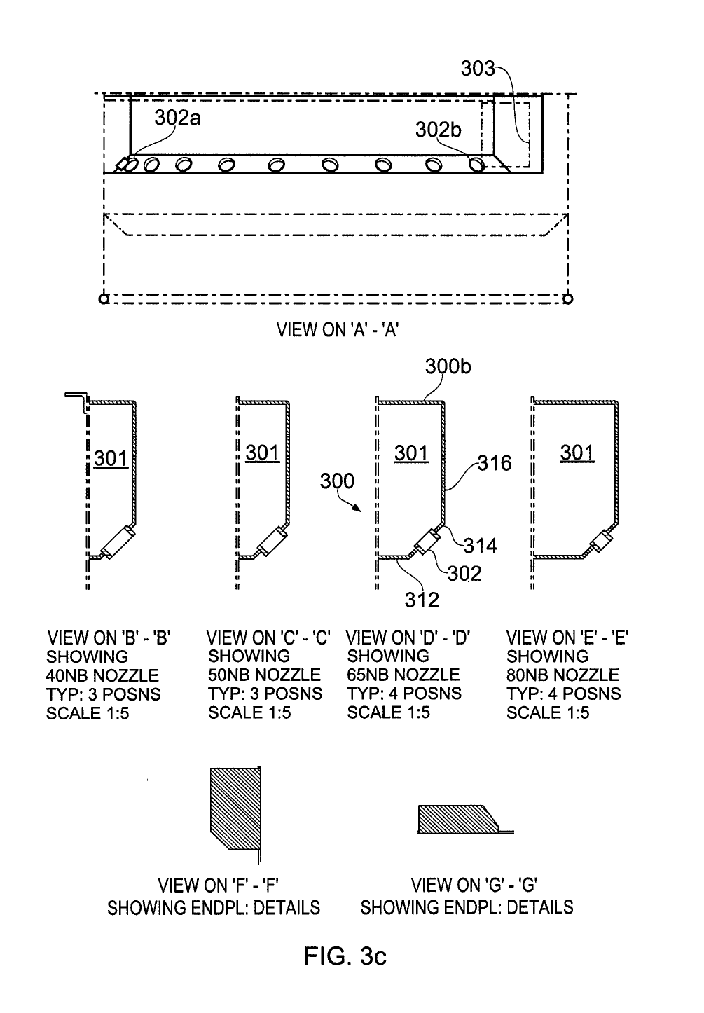

FIG. 3a illustrates a plan view of the underside of an air duct for a pyrothermic reactor;

FIG. 3b illustrates a plan view of a top surface of the air duct of FIG. 3a; and

FIG. 3c illustrates various cross-sectional views of the air duct of FIG. 3a.

A reactor as disclosed herein may economically dispose of waste materials that are not suitable for recycling. A further possible advantage of such a reactor is that latent energy within waste materials can be released and used to produce thermal energy for heating or for the production of electrical energy.

FIG. 1 illustrates a block diagram 100 of a reactor that shows how waste feed material is processed by the reactor. The reactor in this example will be referred to as a pyrothermic reactor (PTR) and comprises a number of heating zones, including a pre-heat zone 102, de-gasification zone 106, pyrothermic zone 108 and a molten zone 110.

A feed material 111 such as waste from residential, commercial or industrial establishments is fed into the pre-heat zone 102. The pre-heat zone operates at a pre-heat temperature, which may be between about 300° C. and 400° C. In this example the pre-heat temperature is 350° C. The pre-heat zone 102 may remove water vapour from the feed material. The pre-heat zone 102 is heated using hot air 103, which may be provided by an external source of energy or may be provided by, or heated by, exhaust gasses from a subsequent stage in the reactor process. A by-product from pre-heating in the pre-heat zone 102 is hot air and water vapour. The hot air and water vapour remain within the reactor and are involved in phase changes to the feed material that subsequently take place in the de-gasification zone 106, pyrothermic zone 108 and molten zone 110.

After pre-heating, material passes into the de-gasification zone 106. The de-gasification zone 106 operates at a de-gasification temperature, which may be between about 350° C. and 500° C. In this example the de-gasification temperature is 400° C. The de-gasification zone 106 removes components from the feed material that take a gas or vapour form below the de-gasifier temperature. De-gasification is a term used to describe the removal of gasses from the solid feed material 111. De-gasification is performed using hot air 103, similar to that described above in the pre-heat zone 102. However, the temperature necessary to perform de-gasification may be slightly higher than that required for pre-heating.

Some combustion may also occur in the de-gasification zone 106. Such combustion may be used to remove environmental oxygen that has been admitted into the reactor with the feed material 111.

After de-gasification the solid, de-gassified feed material is fed into the pyrothermic zone 108 of the reactor to undergo pyrolysis. It should be noted that the pyrothermic zone 108 may not necessarily be totally devoid of oxygen. However, the pyrothermic process that occurs in the pyrothermic zone 108 is a generally anaerobic degradation or decomposition. The pyrothermic zone 108 operates at a pyrothermic temperature, which may be between about 1100° C. and 1350° C. In this example the pyrothermic temperature is 1275° C. In the pyrothermic zone 108, the feed material is degraded by the application of a substantial heat in the absence of oxygen. The pyrolysis results in the release of gasses from the feed material due to the degradation of the feed material. The composition of the gasses therefore depends upon the original feed material. The heat in the pyrothermic zone 108 is received through thermal contact with the molten zone 110 as shown in FIG. 1 by arrows 119. Therefore, the pyrothermic zone 108 is heated by a heater 112 that heats the molten zone 110, as will be described below.

The molten zone 110 receives the feed material 111 and the released gasses from the pyrothermic zone 108. The molten zone 110 operates at a molten temperature, which may be between about 1400° C. and 2000° C. In this example the molten temperature is 1700° C. At these elevated temperatures most waste feed materials become molten feed material.

A heater 112 is used to heat the molten zone 110. In this example, the heater 112 comprises a burner that burns fuel oil 114 received from an external fuel source with combustion air 116. The fuel oil 114 is treated with an atomizing air stream 118 prior to combustion.

The heater 112 in this example is rated to a heater temperature of 1300° C., although in other embodiments could be rated to a heater temperature between 1100° C. and 1400° C. Therefore, one would expect the molten temperature to have an upper limit that is equal to or less than the heater temperature. However, due to the upstream processing of the waste material 111 in one or more of the pyrothermic zone 108, de-gasification zone 106 and pre-heat zone 102, the molten temperature in the molten zone 110 can be elevated beyond the heater temperature.

The difference in temperature between the heater temperature (1300° C.) and the operating temperature of the molten zone 110 (1700° C.) is attributed to the combustion of the released gasses received from the pyrothermic zone 118 and provided to the vicinity of the burner and the molten zone 110. The high molten temperature in the molten zone 110 represents a significant advantage as waste material can be broken down in such a way that would not be possible at the rated temperature of the heater 112. One of the principal features of the pyrothermic reactor (PTR) is the operating temperature of the molten zone 110. Other advantages provided by such examples can be an improved thermal efficiency, lower operating cost, reduced maintenance costs and small envelope size.

In order to sustain a high temperature, the region of the apparatus that houses the molten zone 110 may be provided using a refractory material.

At least some of the material that has been processed by the molten zone 110 can be considered to act as a molten filter 120. The molten zone 110 can be considered to comprise the molten filter 120. The molten filter 120 provides the function of filtering liquid material provided by processing in the molten zone 110 in a similar way that a molten filter 120 in a metallurgical furnace filters a molten metal. The molten filter 120 can allow non-carbonaceous (also referred to as non-carbonious) matter to coagulate and form into small globules, or granulates, whilst carbonaceous matter is decomposed within the molten zone 110.

A residue, which typically comprises inert or non-combustible materials can be allowed to run-off from the molten filter 120. Some examples of reactors described herein can provide an overall disposal performance of 98% (that is, the waste output residue can be around only 2% of the mass of the feed material 111) which is considerably higher than many prior art solutions.

The residue is allowed to fall into a quench tank 122, which quickly reduces the temperature of the residue to around 50 to 80° C. The residue may then be considered to be a vitrified solid 124 that is suitable for conventional disposal. The solid waste output residue may itself be utilized by applications that require inert pellets of material.

Exhaust gasses are also released from the molten filter 120. These exhaust gasses, which are typically at 800° C. to 1600° C., can be passed to an attemperator 126. The attemperator, or heat exchanger, extracts heat from the gas so as to provide heat for a pressurized boiler 128, which may be operated at around 800° C. in some examples.

The hot fluid (such as pressurised water and steam) stored in the boiler may be used for heating or power generation applications.

FIG. 2 shows a schematic view, with partial cross-section, of a pyrothermic reactor (PTR) 200. The reactor 200 comprises features and zones that are similar to those described above with reference to FIG. 1. Such features are provided with corresponding reference numerals in the 200 series and will not necessarily be described again in detail with regard to FIG. 2.

The PTR 200 comprises a closed chamber defined within a space bounded by an inner wall 201, an outer wall 205, 207, a top wall 230, a bottom wall 232 and a heater 212. Various zones are provided within the chamber for processing the feed material. These zones include a pre-heat zone 202, a de-gasification zone 206, a pyrothermic zone 208 and a molten zone 210, as discussed below. The zones are vertically disposed relative to each other in this example such that material moves between the various zones under gravity.

The inner wall 201 is frustoconical. The outer wall 205, 207 is generally tubular in shape and co-axial with the inner wall 201. The inner wall 201 is at least partially within the outer wall 205, 207. The portion of the chamber between the inner wall 201 and the outer wall 205, 207, defines a toroidal portion of the chamber. This toroidal portion of the chamber increases in thickness as it extends vertically downwards due to the frustoconical nature of the inner wall 201. The toroidal portion of the chamber houses the pre-heat zone 202, de-gasification zone 206 and pyrothermic zone 208 in this example, which are located adjacent to each other in this order from top to bottom in the toroidal chamber. The processing that occurs in each of these zones is discussed above in relation to FIG. 1.

The outer wall 205, 207 is longer than the inner wall 201 such that it extends to a lower position than the bottom edge of the inner wall 201. Therefore, the chamber also includes a cylindrical portion underneath the toroidal portion, which is below the bottom edge of the inner wall 201. The cylindrical portion of the chamber houses the molten zone 210 and molten filter 220 that are discussed above in relation to FIG. 1. The molten filter 220 can be considered as being located in the bottom of the molten zone 210 or can be considered as being adjacent to and below the molten zone 210.

The top wall 230 and the bottom wall 232 are substantially horizontal in this example. The top wall 230 extends between an upper edge of the inner wall 201 and an upper edge of the outer wall 205, 207 in order to close the top of the toroidal portion of the chamber. The bottom wall 232 adjoins the lower edge of the outer wall 205, 207 thereby closing the bottom of the cylindrical portion of the chamber. The bottom wall 232 includes a material outlet aperture 213 for material to exit the chamber.

The heater 212 is provided within the frustoconical shape defined by the inner wall 201, and therefore is located in a central cavity of the toroidal portion of the chamber. The heater 212 adjoins the bottom edge of the inner wall 201 and closes off the top of the cylindrical portion of the chamber that would otherwise open out into the central cavity of the toroidal portion of the chamber. The heater 212 provides heat to the cylindrical portion of the chamber.

The chamber can be considered as having a U-shaped cross-section through the centre of the chamber, with the toroidal portion of the chamber forming the vertical parts of the ‘U’ and the cylindrical portion forming the bottom generally horizontal portion of the ‘U’.

The chamber has a number of apertures including an air inlet aperture and material inlet aperture 211 in the toroidal portion, and a material outlet aperture 213 in the cylindrical portion.

The material inlet aperture 211 allows feed material for reaction to be admitted into the pre-heat zone 202 at the top of the toroidal portion of the chamber of the PTR 200. In this example, the material inlet aperture 211 is in the outer wall 205, in the vicinity of the top wall 230. Feed material passes through the pre-heat zone 202 and the de-gasification zone 206 to the pyrothermic zone 208 under gravity. The pyrothermic zone 208 in the toroidal portion of the chamber is adjacent to the molten zone 210 in the cylindrical portion of the chamber and is in fluid and thermal communication with the molten zone 210. The temperature of the various zones within the chamber decrease along a vertical upwards direction from the molten zone 210. Suitable temperatures for the various zones are described above with regard to the example of FIG. 1.

The air inlet aperture is provided to allow hot air 203, 236 to be received into the chamber. In this example the hot air 203 is provided to the pre-heat zone 202 and de-gasification zone 206 in the toroidal portion of the chamber. An optional air duct (not shown) that extends inside and around the top of the chamber may be provided. The air duct may comprise an array of air inlet apertures to improve the distribution of hot air within the chamber. The arrangement of the air inlet apertures and the air duct is discussed further with regard to FIG. 3, below.

The heater 212 injects a combusting fuel and air mixture into the molten zone 210 in the cylindrical portion of the chamber. The molten zone 210 is situated at the bottom of the chamber and is the hottest zone in the chamber. A molten filter 220 sits within the molten zone 210 and covers the material outlet aperture 213. The molten filter 220 provides the function of filtering residue provided by processing in the molten zone 210. Material must pass through the molten filter 220 in order to reach the material outlet aperture 213. The outlet aperture 213 allows reside to pass from the molten zone 210 into a quench tank 222, which is located underneath the material outlet aperture 213. The residue in this example is expelled from the PTR 200 under the force of gravity and undergoes a vertical drop into the quench tank 222.

In this example, the outer wall has a supporting portion 205 and a rotatable mid-portion 207. The supporting portion 205 comprises an upper supporting portion 205a and a lower supporting portion 205b. The upper supporting portion 205a is situated directly above the rotatable mid-portion 207. The lower supporting portion 205b is situated directly below the rotatable mid-portion 207. In this example, the upper supporting portion 205a and the rotatable mid-portion 207 are both cylindrical and coaxially engaged. The lower supporting portion 205b is a cylindrical sub-portion that is coaxially engaged with the rotatable mid-portion 207. The cylindrical sub-portion is connected to a frustoconical sub-portion of the lower supporting portion 205b. The bottom edge of the frustoconical sub-portion is enclosed by the bottom wall 232.

A drive shaft 209 member is associated with and connected to the supporting portion 205 and the rotatable mid-portion 207 in order to rotate the rotatable mid-portion 207 with respect to the supporting portion 205. The upper and lower supporting portions 205a, 205b may be provided in a fixed position. In this example, the upper supporting portion 205a is in a fixed relative position to the inner wall 201. The rotatable mid-portion 207 enables rotational forces to be applied to the molten feed material within the molten zone 210 and so agitate the molten filter 220, thus reducing the probability of blockage of the material outlet aperture 213 at the bottom of the molten filter 220.

It will be appreciated that this is just one example of how a wall that defines the chamber can be made rotatable relative to another wall that defines the chamber in order to stir feed material within the chamber.

An exhaust flue 226 is provided transverse to the path between the material outlet aperture 213 and the quench tank 222 in order to remove hot gasses that are expelled from the material outlet aperture 213. An after burner 225 is optionally provided co-axially with the exhaust flue 226. The after burner 225 may be desirable in some applications in order to direct the exhaust gasses through the exhaust flue 226 during start-up while the PTR gets up to working temperature.

Heat from the exhaust flue 226 is optionally reclaimed using a heat exchanger 228 disposed around the exhaust flue 226. The heat from the heat exchanger 228 can be used to heat clean air 234 from the environment and use it as hot air 203 for the pre-heat zone 202 and the de-gasification zone 206. Such hot air 203 is communicated by conduits to the air inlet aperture.

Additional heat can be extracted from the exhaust flue gasses by a recuperator 230 in order to do useful work. In this example, a recuperator 230 is provided along a vertical portion of the exhaust flue 226. The final portion of the exhaust flue 226 emits the cooled exhaust gasses to the environment. Emission monitoring equipment 232 may be provided in combination with such an exhaust flue 226 arrangement. Optionally, the exhaust gasses can be provided to the pre-heat zone 202 as pre-heated clean air 236.

FIGS. 3a to 3c illustrates an air duct 300 that is configured to receive hot air from a source that is external to a chamber of a PTR and distribute the hot air to a plurality of positions within the chamber. The air duct 300 may therefore provide improved inlet air flow and distribution to a pre-heat zone or a de-gasification zone of a PTR, which are typically provided within a toroidal portion of the chamber. The air duct may be provided in contact with an outer wall and/or a top wall of the PTR.

The air duct 300 comprises a top wall 300b, a side wall 316, a bottom wall 312, and an oblique wall 314. The top wall 300b is generally parallel to the bottom wall 312. The oblique wall 314 connects the bottom wall 312 to the side wall 316. The side wall 316 extends between the top wall 300b and the oblique wall 314. An open side between the top wall 300b and bottom wall 312 (which is opposite the side wall 316) is closed off by an inner surface of an outer wall of the PTR. A plurality of apertures are provided in the oblique wall 314. In this way, the air duct 300 and outer wall of the PTR defines a plenum 301 for communicating hot air from an air intake 303 to the chamber of the PTR through the plurality of apertures 302.

Alternatively, the air duct may be provided as a tubular air duct, with no open side, in which case the plenum is defined entirely by walls of the air duct.

FIG. 3a illustrates a view from below the air duct 300 and shows the arrangement of air inlet apertures 302a, 302b provided in the oblique wall 314 of the air duct 300.

The size of the plurality of apertures 302a, 302b can increase as a function of distance along the air duct 300 from the air intake 303, although each of the apertures illustrated in FIG. 3a are of a uniform size. The provision of an air duct with apertures that increase as a function of distance along the air duct 300 from the air intake 303 can improve the equality of hot air pressure delivered to different locations within the chamber. The smallest size aperture 302a may be provided at marker ‘B’. The largest size aperture 302b may be provided near marker ‘E’. FIG. 3c illustrates cross-sections through these markers, and others.

FIG. 3b illustrates a plan view from above the air duct 300. The air duct 300 has an inner circumference 304 and an outer circumference 306. In this example, the inner circumference 304 has a constant radius with reference to a centre point, whereas a radius of the outer circumference 306 varies with reference to the same centre point so as to provide a narrow end 308 of the air duct 300 and a thick end 310 of the air duct 300. The cross-sectional area of the plenum 301 therefore decreases as a function of distance along the air duct 300 from the intake 303. The thick end 310 of the air duct 300 is aligned with the intake 303 illustrated in FIG. 3a. The provision of such an air duct geometry can improve the equality of hot air pressure delivered to different locations within the chamber of the PTR. In other examples, the radius of the inner circumference 304 may vary and/or the outer circumference 306 may have a constant radius.

FIG. 3c illustrates various views of the air duct of FIG. 3a. These views ('A′'A′ to ‘G’'G′) correspond with cross-sections through the air duct 300 at the corresponding markers illustrated in FIG. 3a.

The view on ‘A’-‘A’ illustrates a cross-sectional view of the air duct 300, which shows the intake 303 adjacent to the thick end 310 of the air duct 300. The cross-sectional views ‘B’-‘B’; ‘C’-‘C’; ‘E’-‘E’; ‘F’-‘F’ and ‘G’-‘G’ of FIG. 3a are shown in FIG. 3c in order to further illustrate the variation in cross-sectional area of the plenum 301 between the narrow end 308 and the thick end 310. The view ‘G’-‘G’ is taken adjacent to the narrow end 308, and shows an endplate that closes the plenum 301 at a position with the smallest cross-section. The view ‘F’-‘F’ is taken adjacent to the thick end 310, and shows an endplate that closes the plenum at a position with the largest cross-section.

Views ‘B’-‘B’; ‘C’-‘C’; and ‘E’-‘E’ intersect the air duct 300 at positions that correspond with apertures 302. The apertures 302 decrease in size through the views ‘B’-'B′ to ‘E’-'E′, which corresponds to the size of the apertures increasing as a function of circumferential distance from the air intake 303. A cross-sectional area of the plenum 301 also increases through the views ‘B’ to ‘E’.

It will be appreciated that features described in regard to one example may be combined with features described with regard to another example, unless an intention to the contrary is apparent.

1. A reactor for processing feed material, comprising:
a de-gasifier zone configured to operate at a de-gasifier temperature and receive the feed material in order to remove components from the feed material that take a gas or vapour form below the de-gasifier temperature;
a pyrothermic zone configured to operate at a pyrothermic temperature and receive the feed material from the de-gasifier zone in order to cause pyrolysis of the feed material to release a gas from the feed material;
a molten zone configured to operate at a molten temperature and receive the feed material and released gas from the pyrothermic zone; and
a heater configured to heat the molten zone to the molten temperature by burning the released gas received from the pyrothermic zone.

2. The reactor claim 1, wherein the heater is rated to a heater temperature that is less than the molten temperature.

3. The reactor of claim 1, wherein the molten temperature is greater than the pyrothermic temperature, and the pyrothermic temperature is greater than the de-gasifier temperature.

4. The reactor of claim 1, wherein the de-gasifier zone is located vertically above the pyrothermic zone, and the pyrothermic zone is located vertically above the molten zone, wherein the feed material is configured to move between the various zones under the action of gravity.

5. (canceled)

6. The reactor of claim 1, further comprising a pre-heat zone configured to operate at a pre-heat temperature and pre-heat the feed material before providing the feed material to the de-gasifier zone, wherein the pre-heat zone is located vertically above the de-gasifier zone.

7. (canceled)

8. The reactor of claim 6, wherein the de-gasifier temperature is greater than the pre-heat temperature.

9. The reactor of claim 6, further comprising a hot air supply configured to heat the de-gasifier zone and/or the pre-heat zone.

10. The reactor of claim 9, wherein the hot air supply is provided by, or heated by, exhaust gasses from the reactor.

11. The reactor of claim 6, wherein, one or more of:
the pre-heat temperature is between 300° C. and 400° C.;
the de-gasifier temperature is between 350° C. and 500° C.;
the pyrothermic temperature is between 1100° C. and 1350° C.;
the molten temperature is between 1400° C. and 2000° C.; and
the heater is rated to a heater temperature between 1100° C. and 1400° C.

12.-15. (canceled)

16. The reactor of claim 1, wherein the heater is a burner that is configured to burn fuel received from an external fuel source.

17. The reactor of claim 1, wherein the heater is also configured to heat the pyrothermic zone to the pyrothermic temperature.

18. The reactor of claim 1, wherein the molten zone is configured to provide a molten filter when in use.

19. The reactor of claim 1, further comprising a chamber having a toroidal portion and a cylindrical portion, wherein the de-gasifier zone and pyrothermic zone are located in the toroidal portion, and the molten zone is provided in the cylindrical portion.

20. The reactor of claim 19, wherein the heater is located in the central cavity of the toroidal portion of the chamber and is configured to apply heat to the molten zone in the cylindrical portion of the chamber.

21. The reactor of claim 19, wherein a wall that defines the chamber is rotatable relative to another wall that defines the chamber in order to stir feed material within the chamber.

22. The reactor of claim 19, wherein the toroidal portion of the chamber comprises an air duct configured to distribute air from an air intake to a plurality of positions around the toroidal portion of the chamber.

23. The reactor of claim 22, wherein the air duct extends around a circumference of the chamber and the air duct comprises a plurality of apertures between a plenum within the air duct and the chamber.

24. The reactor of claim 23, wherein the size of the plurality of apertures increases as a function of distance along the air duct from the air intake.

25. The reactor of claim 23, wherein a cross-sectional area of the plenum of the air duct decreases as a function of distance along the air duct from the air intake.

26. A method of processing feed material, comprising:
receiving the feed material in a de-gasifier zone, and operating the de-gasifier zone at a de-gasifier temperature and in order to remove components from the feed material that take a gas or vapour form below the de-gasifier temperature;
receive the feed material in a pyrothermic zone from the de-gasifier zone, and operating the pyrothermic zone at a pyrothermic temperature in order to cause pyrolysis of the feed material to release a gas from the feed material;
receiving the feed material and released gas in a molten zone from the pyrothermic zone, and operating the molten zone at a molten temperature; and
heating the molten zone to the molten temperature by a heater burning the released gas received from the pyrothermic zone.

27. (canceled)

28. (canceled)
